(19) United States
(12) Patent Application Publication
(10) Pub. No.: US 2023/0379649 A1
(43) Pub. Date: Nov. 23, 2023

(54) EXTENDED REALITY SOUND SIMULATIONS

(71) Applicant: HEWLETT-PACKARD DEVELOPMENT COMPANY, L.P., Spring, TX (US)

(72) Inventors: Cristina Gonzalez Delgado, Sant Cugat del Valles (ES); Brianna Havlik, Fort Collins, CO (US); Annarosa Multari, Sant Cugat del Valles (ES); Pushpalatha Kenchanahalli Rangaswamy, Bangalore (IN)

(73) Assignee: HEWLETT-PACKARD DEVELOPMENT COMPANY, L.P., Spring, TX (US)

(21) Appl. No.: 17/750,724

(22) Filed: May 23, 2022

(51) Int. Cl. H04S 7/00; G06F 3/01

(52) U.S. Cl. CPC H04S 7/304; G06F 3/017; H04R 2499/15; H04S 2400/11

(57) ABSTRACT

The present specification describes examples of a computing device for generating an extended reality environment. The example computing device includes a processor to receive placement data for a virtual sound source within the extended reality environment based on a user action within the extended reality environment. The processor is also to simulate sound generated by the virtual sound source within the extended reality environment based on a user location within the extended reality environment. Sound may be simulated by the processor according to virtual sound source characteristics and interaction with virtual objects. The computing device also includes an extended reality data capture module to capture the placement data and modifications to the virtual sound source within the extended reality environment; and capture the user location within the extended reality environment. The computing device further includes a sound generation device to generate an audible sound of the simulated sound.

### BACKGROUND

Extended reality systems allow a user to become immersed in an extended reality environment wherein they can interact with an enhanced or virtual environment. Extended reality systems include augmented reality, virtual reality, and mixed reality systems that involve users interacting with real and/or perceived aspects of an environment to manipulate and/or interact with that environment.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device for simulating sound in an extended reality environment according to an example of the principles described herein.

FIG. 2 illustrates a view of an extended reality environment, according to an example.

FIG. 3 illustrates a second view of the extended reality environment, according to an example.

FIG. 4 is a flowchart showing a method for extended reality sound simulations according to an example of the principles described herein.

FIG. 5 depicts a non-transitory computer-readable storage medium for simulating sounds in an extended reality environment, according to an example of the principles described herein.

FIG. 6 is a block diagram illustrating processes to generate a simulated sound in an extended reality environment according to an example of the principles described herein.

FIG. 7 is a flowchart showing a method for extended reality sound simulations according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Sound plays a large role in experiencing an environment. For example, the physical surroundings in a space impact the way sound is perceived. In an architectural setting, the configuration of walls, floors, ceilings and other structures will interact with the sound waves that a listener hears. Furthermore, objects (e.g., furniture, rugs, light fixtures, etc.) and even human bodies within an environment may affect the way sound is experienced in the environment.

In some examples, the sound experience of an environment may be assessed. For example, an architect may wish to determine how sound will be perceived in a building that is being designed. In another example, a sound engineer may wish to evaluate the placement of speakers within a concert venue. In yet another example, a homeowner may wish to evaluate a home theater design to help in choosing the components and placement of the components in the home theater. It should be noted that when evaluating the sound experience of an environment, sound may be experienced differently as a listener moves through the space. For example, a person located at the front of a room may hear a sound from differently that a person located at the back of a room.

In some approaches, people or companies seeking to recreate sound distribution in a space (e.g., for sound equipment testing, music events dedicated rooms (e.g., auditoriums, concert halls, theaters, etc.)) may either create a real physical set up of the space to evaluate the sound characteristics of the space. In some examples, spaces may be evaluated using software that models the sound wave distribution in that space. However, in these approaches, it is difficult for a user to evaluate a sound experience while being immersed in the space.

According to the present specification, the sound experience may be simulated using extended reality approaches as described herein. Extended reality systems immerse a user in a world that mimics a real-world experience. In the example of a virtual reality system, a head-mounted display (HMD), using stereoscopic display devices and speakers, allows a user to see, hear and become immersed in any processor-executed virtual scene. Examples of extended reality (also referred to as XR) include virtual reality, augmented reality, and mixed reality.

The extension of the extended reality environment into the real-world may allow a user to simulate the sound experience within an extended reality environment. In some examples, the extended reality environment may be modeled after a real-world environment that is either in existence or is being designed.

The examples described herein provide extended reality approaches for acoustics simulation and design. Using an extended reality system, sound sources of interest and other objects may be added to an extended reality environment. The properties of the environment, the sound sources, and the objects within the environment may be defined and modified. For example, hand tracking technology may be used to determine the placement of sound sources and objects in the extended reality environment. Hand tracking may also be used to determine modifications to the sound sources and objects within the extended reality environment. These approaches allow a user to move freely in the extended reality environment while experiencing the sounds at the different locations within the extended reality environment. In some examples, spatial audio may be used to cause the impression that the listener is surrounded by the sound sources and the audio signals change according to the relative position of the user.

The present specification describes a computing device generating an extended reality environment that includes a processor to receive placement data for a virtual sound source within the extended reality environment based on a user action within the extended reality environment. The processor is also to simulate sound generated by the virtual sound source within the extended reality environment based on a user location within the extended reality environment. The computing device also includes an extended reality data capture module to capture the placement data and modifications to the virtual sound source within the extended reality environment; and capture the user location within the extended reality environment. The computing device further includes a sound generation device to generate an audible sound of the simulated sound.

The present specification also describes a method that includes with a processor: placing a virtual sound source within an extended reality environment based on user actions captured by an extended reality data capture module; placing a virtual object within the extended reality environment based on user actions captured by the extended reality data capture module; and simulating sound generated by the virtual sound source that interacts with the virtual object within the extended reality environment based on a user location within the extended reality environment.

The present specification further describes a non-transitory computer readable storage medium comprising computer usable program code embodied therewith, the computer usable program code to, when executed by a processor: place a plurality of virtual sound sources within the extended reality environment based on user actions within the extended reality environment; track a user movement within the extended reality environment; and simulate sound generated by the plurality of virtual sound sources within the extended reality environment based on the user movement within the extended reality environment.

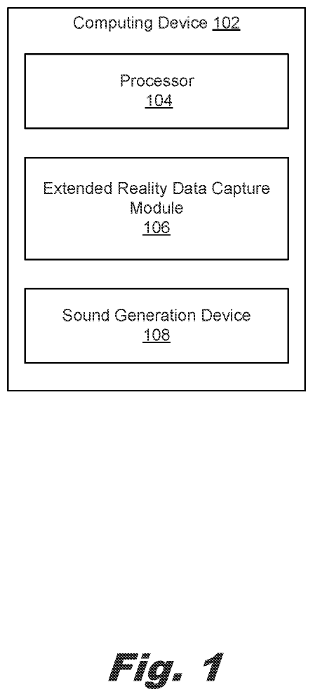

Turning now to the figures, FIG. 1 is a block diagram of a computing device 102 for simulating sound in an extended reality environment according to an example of the principles described herein. The computing device 102 may be any type of computing device including servers, desktop computers, laptop computers, personal digital assistants (PDAs), mobile devices, smartphones, gaming systems, and tablets, head mounted display (HMD) device, among other electronic devices. The computing device 102, to generate an extended reality environment and complete the functionality described herein, may include a processor 104. The processor 104 may execute computer readable program code to generate the extended reality environment as described herein.

In an example, the computing device 102 may include a data storage device (not shown). The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor 104 may boot from Read Only Memory (ROM), maintain nonvolatile storage in the Hard Disk Drive (HDD) memory, and execute program code stored in Random Access Memory (RAM). The data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The computing device 102 may also include an extended reality data capture module 106 to capture user actions that interact with an extended reality environment. For example, sensors may capture user movements. Information captured by these sensors may be interpreted by the processor 104 within the context of the extended reality environment. In some examples, the extended reality data capture module 106 may include cameras to capture a user's actions and/or the user's physical environment. In some examples, the extended reality data capture module 106 may include inertial sensors (e.g., accelerometers, gyroscopes, etc.) to detect changes in orientation, pose, motion of the user. In some examples, the extended reality data capture module 106 may be implemented as a hardware device (e.g., circuitry and instructions) that is separate from the processor 104. In some examples, the extended reality data capture module 106 may include instructions executed by the processor 104. As used herein, the term “module” may include circuitry and/or instructions to implement an operation on the computing device.

In some examples, the extended reality data capture module 106 may perform hand tracking of a user. In some examples, the extended reality data capture module 106 may track a controller held by a user. For example, a combination of inertial sensors in the controller and a camera (e.g., located in an HMD or the controller itself) may be used to determine the location and pose of a user's hand. As a user moves the controller, the controller movement may be translated into the extended reality environment. In some examples, the extended reality data capture module 106 may perform hand tracking of a user based on observations of the user's hands. For example, a camera (e.g., located in an HMD worn by the user) may capture images of the user's hand. Using these images, movements and gestures made by the user's hands may be translated into the extended reality environment.

The processor 104 may generate an extended reality environment. For example, the processor 104 may receive a model of defining the extended reality environment. In some examples, the model may be a three-dimensional (3D) model that defines a virtual space. In an example, the extended reality environment may be a room with defined walls, floor, and ceiling. Other features of the extended reality environment may include windows, furniture, light fixtures, HVAC equipment, or other features that are in a fixed or relatively fixed location. In some examples, the extended reality environment may include other objects may appear in the extended reality environment such as flooring (e.g., carpeting, wood, tile), vegetation, window treatments, water features, etc. In some examples, the extended reality environment may include physical bodies (e.g., human bodies) to simulate sound impacts in a crowded setting.

The processor 104 may generate the extended reality environment by loading the model of the extended reality environment for presentation to the user. For example, images of the extended reality environment may be displayed to a user on an HMD. Furthermore, a sound generation device 108 (e.g., a speaker or set of speakers) may produce audible sounds of the extended reality environment that a user can hear.

In some examples, the processor 104 may generate a virtual reality environment based on a 3D model of a space. In some examples, the processor 104 may generate an augmented reality environment based on a model of the physical space in which the computing device 102 is located.

In this example, the processor 104 may receive placement data for a virtual sound source within the extended reality environment based on a user action within the extended reality environment. As used herein a virtual sound source is a sound generating feature in the extended reality environment. For example, the virtual sound source may be a representation of a sound generating device (e.g., a speaker, a musical instrument, an automobile, etc.), a sound-emitting body (e.g., a human body, an animal, etc.), or other entity that produces a sound.

In some examples, the placement data may include information about the virtual sound source and a location within the extended reality environment in which the virtual sound source is located. For example, a user may select a virtual sound source for placement in the extended reality environment. In some examples, the virtual sound source may include a simulated speaker or other sound generating device. The user may place the virtual sound source within the extended reality environment while immersed within the extended reality environment.

In some examples, the extended reality data capture module 106 is to capture the placement data and modifications to the virtual sound source within the extended reality environment. For example, the extended reality data capture module 106 may perform hand tracking of a user to identify a user selection of a virtual sound source. The extended reality data capture module 106 may also determine where in the extended reality environment the user places the virtual sound source based on hand tracking.

In some examples, the extended reality data capture module 106 may capture modifications to the virtual sound source and/or the location of the virtual sound source within the extended reality environment. For example, once a user places the virtual sound source, the user may change the virtual sound source while within the extended reality environment. In some examples, the user may change the location of the virtual sound source within the extended reality environment.

The processor 104 may receive a user selection of the virtual sound source. For example, while in the extended reality environment, the user may select a given virtual sound source for placement within the extended reality environment. Upon receiving the user selection, the processor 104 may determine source sound characteristics for the virtual sound source based on the user selection. For example, the processor 104 may reference a library of stored sound characteristics for the virtual sound source. The sound characteristics may include audio parameters for how the virtual sound source is to produce sound. For example, in the case of speakers, a speaker manufacturer may provide sound models that characterize the performance of a particular speaker. In some examples, an FMOD library may provide sound characteristics for the virtual sound source placed in the extended reality environment.

It should be noted that a virtual sound source may have active sound characteristics and passive sound characteristics. As used herein, active sound characteristics include parameters describing how the virtual sound source generates sound. As used herein, passive sound characteristics include parameters describing how the virtual sound source interacts with external sound waves that encounter the virtual sound source. For example, a speaker generates sound and may reflect sound waves within an environment. The source sound characteristics may define both active sound characteristics and passive sound characteristics.

In some examples, the source sound characteristics may include a sound that is to be emitted by the virtual sound source. For example, a user may select a sound that the virtual sound source is to generate. The sound may be a recorded audio file (e.g., a music recording, human speech recording) or may be a synthesized sound generated by the processor 104. In an example where the virtual sound source is a speaker, the user may select a recorded music file that is to be emitted by the speaker. In another example where the virtual sound source is a fan, the processor 104 may synthesize sounds generated by the fan based on stored properties of the fan.

In some examples, the user may place a virtual object within the extended reality environment. As used herein, a virtual object is an entity within the extended reality environment that interacts with sound but does not generate sound. For example, a virtual object may reflect and/or absorb sound generated by the virtual sound source. Thus the virtual object may modify the sound experience within the extended reality environment, but does not produce the sound. Some examples of a virtual object includes chairs, tables, television sets, cabinets, books, flooring (e.g., carpeting, wood, tile), vegetation, window treatments, water features, and bodies (e.g., human spectators).

In some cases an entity may be a virtual sound source or a virtual object. For example, a human may be a virtual sound source when vocalizing (e.g., singing). In other examples, a human (e.g., a spectator) may be a virtual object when interacting with an emitted sound. Thus, a user may select an entity to be either a virtual sound source or a virtual object when placing the entity in the extended reality environment.

As with the virtual sound source, the processor 104 may receive object sound characteristics for a virtual object placed within the extended reality environment. For example, the processor 104 may reference a library of stored sound characteristics for the virtual object when a user selects a virtual object. In some examples, an FMOD library may provide sound characteristics for the virtual objects placed in the extended reality environment. The sound characteristics may include audio parameters for how the virtual object is to modify sound. For example, a virtual object may have material properties that reflect or absorb sound. In an example, a fabric chair may absorb (e.g., dampen) sound emitted from a virtual sound source while a metal chair may reflect sound emitted from a virtual sound source.

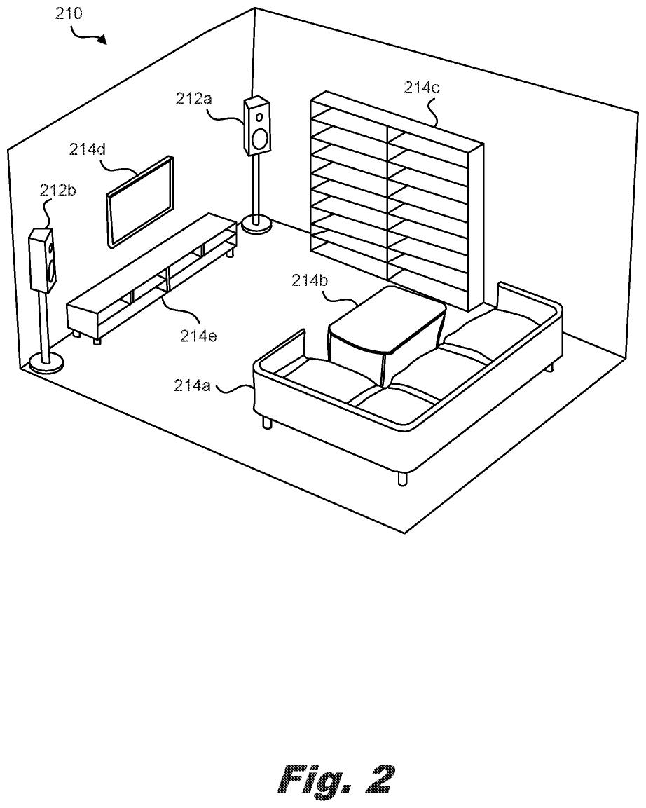

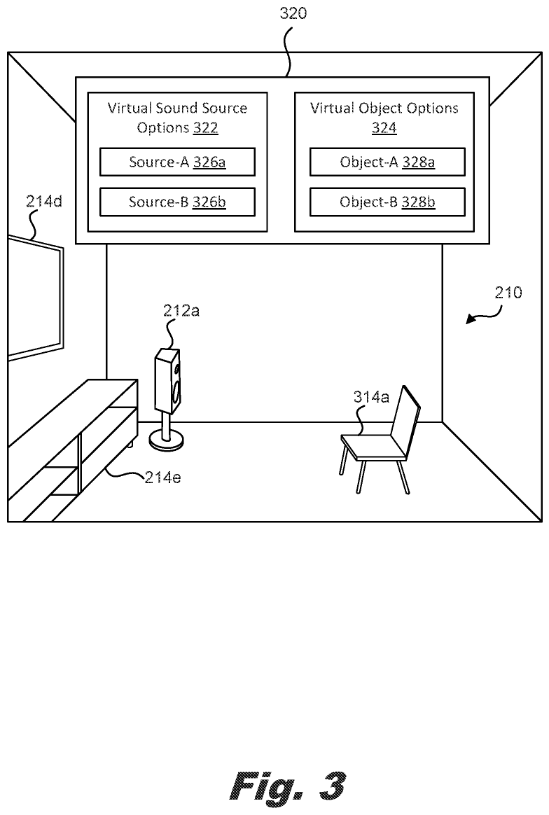

Examples of an extended reality environment for sound simulation are described in connection with FIGS. 2 and 3. Referring to FIG. 2, a view of an extended reality environment 210 is provided. In this example, the extended reality environment 210 includes a room with a floor, walls, and ceiling (not shown). The surfaces defining the room may be loaded from a 3D model of the extended reality environment 210. A user wearing an extended reality headset (e.g., HMD) may select and place a first virtual sound source 212a (e.g., a first speaker) within the extended reality environment 210. The user may also select and place a second virtual sound source 212b (e.g., a second speaker) within the extended reality environment 210. In this case, the first virtual sound source 212a and the second virtual sound source 212b are located in different corners of the extended reality environment 210. Furthermore, the user has oriented the first virtual sound source 212a and the second virtual sound source 212b at an angle directed toward the center of the extended reality environment 210.

In the example of FIG. 2, the user may select and place a number of virtual objects within the extended reality environment 210. For example, the user may select and place a couch 214a, a table 214b, a shelving unit 214c, a television 214d, and a media console 214e.

FIG. 3 illustrates a second view of the extended reality environment 210. In this case, a user has moved to a different location within the extended reality environment 210 described in FIG. 2. The perspective of the user has changed such that the first virtual sound source 212a and media console 214e are visible.

In this example, the user has modified the extended reality environment 210 to replace the couch (FIG. 2, 214a) with a different chair 314. Furthermore, the user has removed the table (FIG. 2, 214b) and bookcase (FIG. 2, 214c) from the extended reality environment 210. The angle and height of the first virtual sound source 212a has also been modified as compared to FIG. 2. In this manner, the user may immersively modify the sound experience through the selection, placement, and modification of the virtual sound sources and virtual objects in the extended reality environment 210.

In some examples, the processor (FIG. 1, 104) may generate an extended reality user interface 320 displaying virtual sound source options 322 and virtual object options 324 from which a user selects items to place in the extended reality environment 210. For example, the extended reality user interface 320 may appear as a dialog box within the extended reality environment 210. A user may interact with the extended reality user interface 320 using hand tracking, a controller, or through other user feedback.

The virtual sound source options 322 may include a number of virtual sound sources from which a user can choose to place in the extended reality environment 210. For example, Source-A 326a may be a speaker and Source-B 326b may be a musical instrument. In other examples, the virtual sound source options 322 may include groups of virtual sound sources organized into types (e.g., speaker types, musical instrument types, human voice types, etc.).

The virtual object options 324 may include a number of virtual objects from which a user can choose to place in the extended reality environment 210. For example, Object-A 328a may be a chair and Object-B 328b may be a table.

In some examples, the items included in the extended reality user interface 320 may be associated with given sound characteristics. For example, Source-A 326a may have a first set of sound characteristics, Source-b 326b may have a second set of sound characteristics, and so forth. Once a user selects an item from the extended reality user interface 320, the processor (FIG. 1, 104) may determine the sound characteristics of the item from a sound characteristics library.

Returning now to FIG. 1, the processor 104 may simulate sound generated by the virtual sound source within the extended reality environment based on a user location within the extended reality environment. For example, a user may move to different locations within the extended reality environment. In this manner, the user may experience sound within the extended reality environment from different perspectives. In some examples, the extended reality data capture module 106 may capture the user location within the extended reality environment. For example, the computing device 102 may include sensors that the extended reality data capture module 106 uses to track movement of the user.

In some examples, the user location may include the position of the user within the extended reality environment. In this regard, the user movement may include translation of the user within the extended reality environment. In some examples, the extended reality data capture module 106 may track the physical movement (e.g., walking, sitting, turning) of a user. In some examples, the extended reality data capture module 106 may capture virtual movement of the user within the extended reality environment. For instance, a user may use a controller (e.g., handheld controller) to communicate movement within the extended reality environment.

In some examples, the user location may include the orientation of the user's view within the extended reality environment. For example, user movement may include rotation of an extended reality headset worn by the user. These changes to the user's head position may be captured by the extended reality data capture module 106.

The processor 104 may simulate how the sound generated by a virtual sound source will be perceived by the user at a given location in the extended reality environment. For example, the processor 104 may simulate the sound waves emitted by a virtual sound source interacting with virtual objects within the extended reality environment.

In some examples, processor 104 may simulate the sound generated by the virtual sound source based on the source sound characteristics and/or the object sound characteristics. For example, as described above, once a user selects a virtual sound source, the processor 104 may determine the source sound characteristics for that virtual sound source. The processor 104 may then simulate the sound generated by the virtual sound source within the extended reality environment based on the source sound characteristics. This sound simulation may account for the user's location, pose, and/or movement within the extended reality environment.

The processor 104 may also simulate the sound experienced by a user based on object sound characteristics of a virtual object. For example, once a user selects and places a virtual object in the extended reality environment, the processor 104 may determine the object sound characteristics for the virtual object. Using the source sound characteristics for the virtual sound source and the virtual object, the processor 104 may generate a simulated sound based on the user's location within the extended reality environment.

The processor 104 may use a simulation engine to simulate the sound generated by the virtual sound source as experience at a given location in the extended reality environment. For example, the processor 104 may provide the placement data for the virtual sound source and virtual object to the simulation engine. The processor 104 may also provide the model of the extended reality environment and the user location and/or user movement within the extended reality environment to the simulation engine. The processor 104 may further provide the sound characteristics for the virtual sound source and the virtual object to the simulation engine. The simulation may then take these parameters to generate a simulated sound of the virtual sound source as would be perceived by a user at the given user location. Some examples of the simulation engine include audio engines (e.g., FMOD) or game engines (e.g., Unreal Engine, Unity Engine) that apply physics to sounds within a 3D environment.

In some examples, the simulation engine may use spatial audio to simulate sound generated by a single sound source or a plurality of virtual sound sources. The spatial audio allows a user to perceive sounds as coming from physical objects in the extended reality environment. The spatial audio mimics acoustic behavior of sound generated by the virtual sound sources relative to a user location within the extended reality environment.

In some examples, the processor 104 may output the simulated sound for playback as an audible sound. The computing device 102 includes a sound generating device 108 to generate an audible sound of the simulated sound. For example, the processor 104 may output the simulated sound as a digital or analog signal. The signal output by the processor 104 may be formatted such that the sound generating device 108 produces a sound that a user can hear. In some examples, the sound generating device 108 may be a speaker. In some examples, the sound generating device 108 may include multiple speakers capable of recreating spatial audio for a user. In some examples, the sound generating device 108 may be included in a headset worn by the user.

In some examples, the processor 104 may adjust the sound simulation based on user movements. For example, the extended reality data capture module 106 may track user movements within the context of the extended reality environment. In some examples, the user movement may include rotation of an extended reality headset that translates to a change in the user's view in the extended reality environment. In some examples, the user movement may include translation of the user within the extended reality environment.

The processor 104 may adjust the sound generated by the virtual sound source based on the user movement. For example, the processor 104 may account for changes in how the sound emitted by the virtual sound source would interact with the virtual objects and surfaces of the extended reality environment as the sound reaches the user. In some examples, the processor 104 may provide an updated user location to a simulation engine to adjust the simulated sound for the updated user location. Thus, as a user moves through the extended reality environment, the user may experience changes in the sound generated by the virtual sound source. In this manner, the user may evaluate the sound experience from different locations and perspectives.

In some examples, simulating the sound generated by the virtual sound source may include adjusting the sound generated by the virtual sound source based on modifications made by the user to the virtual sound source, other virtual objects, or the extended reality environment itself. For example, while in the extended reality environment, a user may move a virtual sound source and/or virtual object to a different location or orientation. In some examples, a user may add or remove a virtual sound source or virtual object. In some examples, a user may change parameters (e.g., dimensions, materials) of virtual sound sources, virtual objects, and/or surfaces in the extended reality environment. In some examples, a user may add or remove surfaces in the extended reality environment.

In another example, the processor 104 may provide a user interface that provides elements user adjustments to the sound characteristics of a virtual sound source and/or virtual object. For instance, a user may change the physical properties (e.g., material, thickness, reflectivity) of the virtual sound source and/or virtual object. In some examples, a user may change the acoustic properties (e.g., timbre, pitch, intensity, volume, sound file, etc.) of a virtual sound source.

The processor 104 may adjust the simulated sound heard by the user based on the user adjustments. In this manner, the user may evaluate changes to virtual sound sources, virtual objects, or the extended reality environment as the changes are being made.

In some examples, the processor 104 may evaluate the simulated sound to provide recommendations to the user. For example, in response to placement and modifications to virtual sound sources and virtual objects in the extended reality environment, the processor 104 may determine whether the simulated sound within the extended reality environment suffers from quality concerns. For example, the processor 104 may identify low-quality sound regions in the extended reality environment where the simulated sound quality is predicted to be low quality (e.g., due to sound attenuation, interference, distance from a virtual sound source, etc.) based on defined quality criteria. In some examples, the processor 104 may identify high-quality sound regions based on defined criteria for high-quality sound. The processor 104 may indicate to the user the low-quality sound regions and/or high-quality sound regions in the extended reality environment. The user may then move into the low-quality sound regions or high-quality sound regions to experience the simulated sound. The user may make modifications to virtual sound sources, virtual objects, or the extended reality environment itself to attempt to enhance the sound quality in the regions identified as low-quality sound regions by the processor 104.

Because the elements used to simulate sound in the extended reality environment are based on real-world items, a user may apply configurations developed in the extended reality environment to a real-world application. For instance, after evaluating virtual sound sources and virtual objects in the extended reality environment, real-world equivalents to the virtual sound sources and virtual objects may be obtained and placed in a real-world setting matching the extended reality environment.

In some examples, some aspects of the computing device 102 described above may be performed by separate computing devices. For example, the computing device 102 may provide data (e.g., placement data, user location, user movement, hand tracking data, user selections, etc.) to a remote computing device (e.g., a cloud server). In this case, the computing device 102 may include a network adapter for communicating with the remote computing device. The remote computing device may perform the sound simulations as described above. The remote computing device may send the simulated sound back to the computing device 102 for playback by the sound generation device 108. In some examples, the remote computing device may also perform graphical processing to render the extended reality environment. The remote computing device may then send a digital video stream to the computing device 102 for display (e.g., on an HMD) to the user.

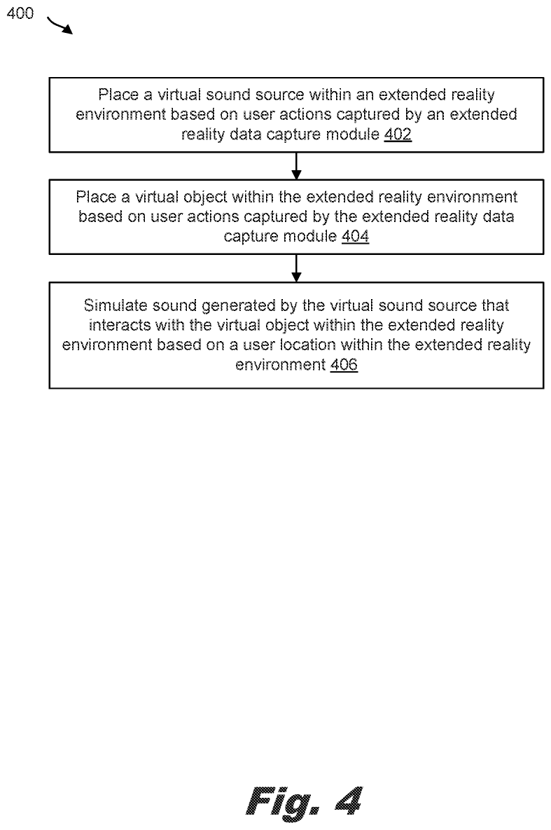

FIG. 4 is a flowchart showing a method 400 for extended reality sound simulations according to an example of the principles described herein. The method 400 may be a method engaged in by the computing device 102 described in connection with FIG. 1 herein.

At 402, the method 400 includes, with a processor 104, placing a virtual sound source within an extended reality environment based on user actions captured by an extended reality data capture module. For example, the extended reality data capture module may capture placement data for placing the virtual sound source in the extended reality environment based on hand tracking of the user as described herein.

At 404, the method 400 includes placing a virtual object within the extended reality environment based on user actions captured by the extended reality data capture module. As described herein, the processor 104 of the computing device 102 may receive a user selection of the virtual object. The extended reality data capture module may capture placement data for placing the virtual object in the extended reality environment based on hand tracking of the user as described herein.

At 406, the method 400 includes simulating sound generated by the virtual sound source that interacts with the virtual object within the extended reality environment based on a user location within the extended reality environment. As described herein, the processor 104 may simulate how the sound generated by a virtual sound source will be perceived by the user at a given location in the extended reality environment. For example, the processor 104 may simulate the sound waves emitted by a virtual sound source interacting with the virtual object within the extended reality environment.

In an example, simulating the sound generated by the virtual sound source includes adjusting the sound generated by the virtual sound source based on modifications to the virtual sound source made by a user in the extended reality environment. Thus, the processor 104 may receive a user modification of sounds output by a single virtual sound source or a plurality of virtual sound sources. The processor 104 may adjust the simulated sound generated by the virtual sound sources based on the user modification. In some examples, the modifications include moving the location or orientation of the virtual sound source. In some examples, the modifications include changing the sound characteristics of the virtual sound source. In some examples, the modifications include changing which selected virtual sound source is selected.

In an example, the method 400 includes tracking movement of the user within the extended reality environment. In some examples, the user movement comprises rotation of an extended reality headset. In some examples, the user movement comprises translation of the user within the extended reality environment. As described herein, the processor 104 may adjust the simulated sound generated by the virtual sound source based on the user movement.

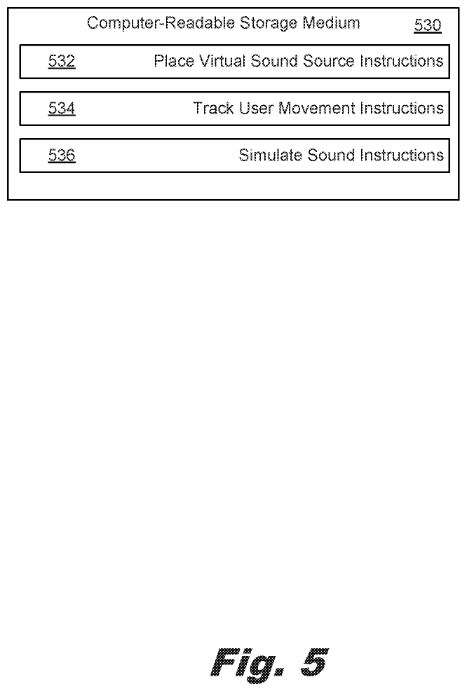

FIG. 5 depicts a non-transitory computer-readable storage medium 530 for simulating sounds in an extended reality environment, according to an example of the principles described herein. For example, non-transitory computer-readable storage medium 530 includes instructions for receiving placement data for a virtual sound source within the extended reality environment based on a user action within the extended reality environment, tracking user movement within the extended reality environment, and simulating sounds in an extended reality environment.

To achieve its desired functionality, the computing device (FIG. 1, 102) includes various hardware components. Specifically, the computing device (FIG. 1, 102) includes a processor (FIG. 1, 104) and a computer-readable storage medium 530. The computer-readable storage medium 530 is communicatively coupled to the processor (FIG. 1, 104). The computer-readable storage medium 530 includes a number of instructions 532, 534, 536 for performing a designated function. In some examples, the instructions may be machine code and/or script code.

The computer-readable storage medium 530 causes the processor to execute the designated function of the instructions 532, 534, 536. The computer-readable storage medium 530 can store data, programs, instructions, or any other computer-readable data that can be utilized to operate the device (FIG. 1, 104). Computer-readable storage medium 530 can store computer usable program code that the processor (FIG. 1, 104) of the computing device (FIG. 1, 104) can process, or execute. The computer-readable storage medium 530 can be an electronic, magnetic, optical, or other physical storage device that contains or stores executable instructions. Computer-readable storage medium 530 may be, for example, Random-Access Memory (RAM), an Electrically Erasable Programmable Read-Only Memory (EEPROM), a storage device, an optical disc, etc. The computer-readable storage medium 530 may be a non-transitory computer-readable storage medium 530.

Referring to FIG. 5, place virtual sound source instructions 532, when executed by the processor (FIG. 1, 104), cause the processor (FIG. 1, 104) to place a plurality of virtual sound sources within the extended reality environment based on user actions within the extended reality environment. For example, the processor (FIG. 1, 104) may receive user selections of multiple virtual sound sources. The processor (FIG. 1, 104) may then receive placement data corresponding to locations within the extended reality environment that the user places the plurality of virtual sound sources.

Track user movement instructions 534, when executed by the processor (FIG. 1, 104), cause the processor (FIG. 1, 104) to track a user movement within the extended reality environment. For example, the user movement may include rotation of an extended reality headset. In some examples, the user movement includes translation of the user within the extended reality environment.

Simulate sound instructions 536, when executed by the processor (FIG. 1, 104), cause the processor (FIG. 1, 104) to simulate sound generated by the plurality of virtual sound sources within the extended reality environment based on the user movement within the extended reality environment. The simulated sound generated by the plurality of virtual sound sources may include spatial audio to allow a user to perceive sounds as coming from physical objects in the extended reality environment. The spatial audio may mimic acoustic behavior of sound generated by the plurality of virtual sound sources relative to a user location within the extended reality environment.

In some examples, the processor (FIG. 1, 104) may receive a user modification of sounds output by the plurality of virtual sound sources. The processor (FIG. 1, 104) may adjust the simulated sound generated by the plurality of virtual sound sources based on the user modification.

In some examples, the processor (FIG. 1, 104) may provide a user recommendation based on the simulated sound. The processor (FIG. 1, 104) may evaluate the simulated sound based on defined acoustic parameters. In some examples, the defined acoustic parameters may indicate sound quality within the extended reality environment. The processor (FIG. 1, 104) may present a visual recommendation to the user.

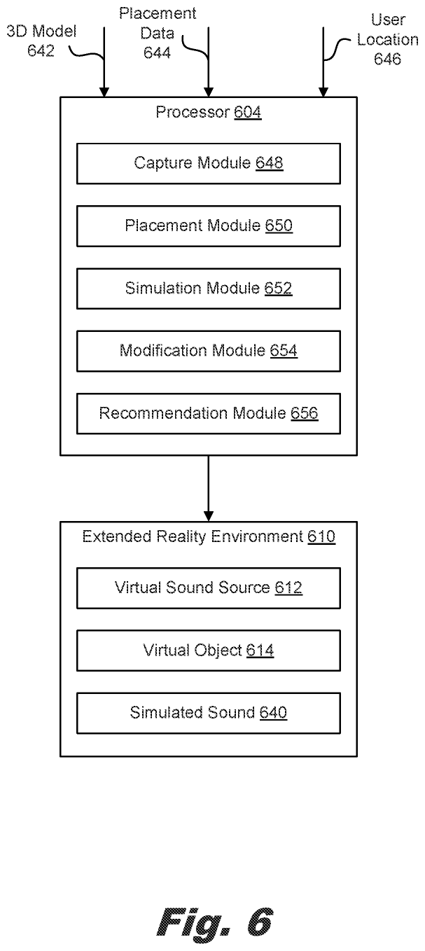

FIG. 6 is a block diagram illustrating processes to generate a simulated sound 640 in an extended reality environment 610 according to an example of the principles described herein. A processor 604 may be implemented as described in FIG. 1. In this example, the processor 604 includes a number of modules to execute various operations to generate a simulated sound 640 in the extended reality environment 610.

The processor 604 may include a capture module 648 to receive information about the extended reality environment 610. For example, the capture module 648 may receive a 3D model 642 of the extended reality environment 610. The capture module 648 may also receive information about a user interacting with the extended reality environment 610. For example, the capture module 648 may detect a user location 646 within the extended reality environment 610, may track user movement within the extended reality environment 610, and may receive placement data 644 for a virtual sound source 612 and virtual object 614 within the extended reality environment 610.

A placement module 650 may place the virtual sound source 612 and virtual object 614 within the extended reality environment 610 based on the placement data 644 provided by the user. For example, a user may select a given virtual sound source 612 and virtual object 614. The user may then locate the virtual sound source 612 at a first location and the virtual object 614 at a second location within the extended reality environment 610. The processor 604 may generate a visual rendering of the virtual sound source 612 and virtual object 614 within the extended reality environment 610.

A simulation module 652 may generate a simulated sound 640 based on the user location 646 within the extended reality environment 610. For example, the simulation module 652 may determine how the sound generated by the virtual sound source 612 interacts with the virtual object 614 (and other objects) and will be perceived at the user location 646 within the extended reality environment 610. In some examples, the simulation module 652 may generate the simulated sound 640 based on sound characteristics assigned to the selected virtual sound source 612 and virtual object 614.

A modification module 654 may determine changes to the virtual sound source 612, the virtual object 614 and/or the extended reality environment 610. For example, a user may modify the virtual sound source 612 by changing the selected virtual sound source 612, by changing the location of the virtual sound source 612, by changing the sound characteristics of the virtual sound source 612, etc. The user may make similar changes to the virtual object 614. In some examples, the user may change the extended reality environment 610 by changing parameters (e.g., materials, dimensions, surface locations) of the extended reality environment 610. The simulation module 652 may then update the simulated sound 640 based on the user modifications.

In some examples, the capture module 648 may detect user movement within the extended reality environment 610. The capture module 648 may cause the simulation module 652 to update the simulated sound 640 based on the user movement. Thus, the user may experience changes in the simulated sound 640 based on movement through the extended reality environment 610.

In some examples, a recommendation module 656 may provide a user recommendation based on the simulated sound 640. This may be accomplished as described in FIG. 1. For example, the recommendation module 656 may evaluate the simulated sound 640 based on defined acoustic parameters. In some examples, the defined acoustic parameters may indicate thresholds for sound quality within the extended reality environment 610. The recommendation module 656 may generate a visual recommendation for display to the user.

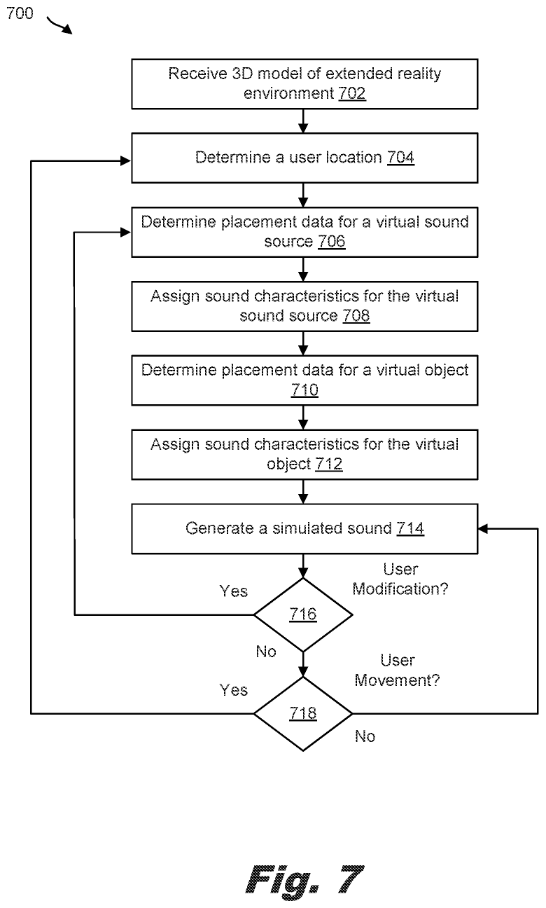

FIG. 7 is a flowchart showing a method 700 for extended reality sound simulations according to an example of the principles described herein. The method 700 may be a method engaged in by the computing device 102 of FIG. 1 or the processor 604 of FIG. 6.

At 702, the method 700 includes receiving a 3D model (FIG. 6, 642) of an extended reality environment (FIG. 6, 610). In some examples, the 3D model (FIG. 6, 642) may be a three-dimensional (3D) model that defines a virtual space.

At 704, the method 700 includes determining a user location (FIG. 6, 646) in the extended reality environment (FIG. 6, 610). For example, an extended reality data capture module (FIG. 1, 106) may capture the user location (FIG. 6, 646) within the extended reality environment (FIG. 6, 610). A computing device may include sensors that the extended reality data capture module 106 uses to track a user's location (FIG. 6, 646) and movement within the extended reality environment (FIG. 6, 610).

At 706, the method 700 includes determining placement data (FIG. 6, 644) for a virtual sound source (FIG. 6, 612). For example, a user may select a given virtual sound source (FIG. 6, 612). The user may then place the virtual sound source (FIG. 6, 612) within the extended reality environment (FIG. 6, 610). At 708, sound characteristics for the virtual sound source (FIG. 6, 612) are assigned. For example, the sound characteristics for the virtual sound source (FIG. 6, 612) may define how the virtual sound source (FIG. 6, 612) is to generate sound within the extended reality environment (FIG. 6, 610). In some examples, the sound characteristics for the virtual sound source (FIG. 6, 612) are obtained from a sound characteristics library. In some examples, a user may provide or modify the sound characteristics for the virtual sound source (FIG. 6, 612).

At 710, the method 700 includes determining placement data (FIG. 6, 644) for a virtual object (FIG. 6, 614). For example, a user may select a given virtual object (FIG. 6, 614). The user may then place the virtual object (FIG. 6, 614) within the extended reality environment (FIG. 6, 610). At 712, sound characteristics for the virtual object (FIG. 6, 614) are assigned. For example, the sound characteristics for the virtual object (FIG. 6, 614) may define how the virtual object (FIG. 6, 614) is to generate sound within the extended reality environment (FIG. 6, 610). In some examples, the sound characteristics for the virtual object (FIG. 6, 614) are obtained from a sound characteristics library. In some examples, a user may provide or modify the sound characteristics for the virtual object (FIG. 6, 614).

At 714, the method 700 includes generating a simulated sound (FIG. 6, 640). For example, a processor may simulate sound generated by the virtual sound source (FIG. 6, 612) that interacts with the virtual object (FIG. 6, 614) within the extended reality environment (FIG. 6, 610) based on the user location within the extended reality environment (FIG. 6, 610). The processor may apply the sound characteristics of the virtual sound source (FIG. 6, 612), the virtual object (FIG. 6, 614), and/or the extended reality environment (FIG. 6, 610) when generating the simulated sound (FIG. 6, 640). In some examples, the simulated sound (FIG. 6, 640) may be played by a sound generation device as an audible sound.

At 716, the method 700 includes determining whether a user modification has been received. For example, a user may make changes to the virtual sound source (FIG. 6, 612), the virtual object (FIG. 6, 614), or the extended reality environment (FIG. 6, 610). If a user modification occurs (716 YES), then the method 700 may return to 704 to adjust the simulated sound (FIG. 6, 640) according to the user modification.

If no user modification is detected, (716 NO), then the method 700 includes determining whether user movement within the extended reality environment (FIG. 6, 610) has occurred. If a user movement occurs (718 YES), then the method 700 may return to 702 to adjust the simulated sound (FIG. 6, 640) based on the user movement to a new user location. If no user movement is detected, (718 NO), then the method 700 continues to generate the simulated sound (FIG. 6, 640) at 714.

The preceding description has been presented to illustrate and describe examples of the principles described. This description is not intended to be exhaustive or to limit these principles to any precise form disclosed. Many modifications and variations are possible in light of the above teaching.

What is claimed is:

1. A computing device generating an extended reality environment, comprising:
a processor to:
receive placement data for a virtual sound source within the extended reality environment based on a user action within the extended reality environment;
simulate sound generated by the virtual sound source within the extended reality environment based on a user location within the extended reality environment;
an extended reality data capture module to:
capture the placement data and modifications to the virtual sound source within the extended reality environment; and
capture the user location within the extended reality environment; and
a sound generation device to generate an audible sound of the simulated sound.

2. The computing device of claim 1, wherein the processor is to:
receive object sound characteristics for a virtual object placed within the extended reality environment; and
simulate the sound generated by the virtual sound source within the extended reality environment based further on the object sound characteristics.

3. The computing device of claim 1, wherein the processor is to:
receive a user selection of the virtual sound source, and
determine source sound characteristics for the virtual sound source based on the user selection.

4. The computing device of claim 3, wherein the processor is to:
simulate the sound generated by the virtual sound source within the extended reality environment based further on the source sound characteristics.

5. The computing device of claim 1, wherein the processor is to:
generate an extended reality user interface displaying virtual sound source options and virtual object options from which a user selects to place in the extended reality environment.

6. The computing device of claim 1, wherein the extended reality data capture module is to capture the placement data based on hand tracking of a user.

7. A method, comprising:
with a processor:
placing a virtual sound source within an extended reality environment based on user actions captured by an extended reality data capture module;
placing a virtual object within the extended reality environment based on user actions captured by the extended reality data capture module; and
simulating sound generated by the virtual sound source that interacts with the virtual object within the extended reality environment based on a user location within the extended reality environment.

8. The method of claim 7, wherein simulating the sound generated by the virtual sound source comprises adjusting the sound generated by the virtual sound source based on modifications to the virtual sound source made by a user in the extended reality environment.

9. The method of claim 7, further comprising:
tracking movement of the user within the extended reality environment; and
adjusting the simulated sound generated by the virtual sound source based on the user movement.

10. The method of claim 9, wherein the user movement comprises rotation of an extended reality headset.

11. The method of claim 9, wherein the user movement comprises translation of the user within the extended reality environment.

12. A non-transitory computer-readable storage medium comprising computer usable program code embodied therewith, the computer usable program code to, when executed by a processor:
place a plurality of virtual sound sources within an extended reality environment based on user actions within the extended reality environment;
track a user movement within the extended reality environment; and
simulate sound generated by the plurality of virtual sound sources within the extended reality environment based on the user movement within the extended reality environment.

13. The non-transitory computer readable storage medium of claim 12, wherein the simulated sound generated by the plurality of virtual sound sources comprises spatial audio to allow a user to perceive sounds as coming from physical objects in the extended reality environment.

14. The non-transitory computer readable storage medium of claim 12, further comprising computer usable program code to, when executed by a processor:
provide a user recommendation based on the simulated sound.

15. The non-transitory computer readable storage medium of claim 12, further comprising computer usable program code to, when executed by a processor:
receive a user modification of sounds output by the plurality of virtual sound sources; and
adjust the simulated sound generated by the plurality of virtual sound sources based on the user modification.
